(19) United States
(12) Patent Application Publication
(10) Pub. No.: US 2026/0073936 A1
(43) Pub. Date: Mar. 12, 2026

(54) System and Method for Non-Intrusive Speech Intelligibility Estimation

(71) Applicant: Microsoft Technology Licensing, LLC, Redmond, WA (US)

(72) Inventors: James W. Fosburgh, Baltimore, MD (US); Dushyant Sharma, Mountain House, CA (US); Patrick A. Naylor, Berkshire (GB)

(21) Appl. No.: 18/829,099

(22) Filed: Sep. 9, 2024

(51) Int. Cl. G10L 25/60; G10L 25/30

(52) U.S. Cl. CPC G10L 25/60; G10L 25/30

(57) ABSTRACT

A method, computer program product, and computing system for non-intrusive speech intelligibility estimation. A degraded audio signal is processed in a pretrained automatic speech recognition (ASR) system; ASR encoder features of the degraded audio signal are generated; the ASR encoder features are processed to identify patterns in the ASR encoder features; patterns that represent levels of intelligibility of the audio signal are recognized; and a predicted intelligibility of the audio signal based on the recognized patterns of the ASR encoder features is determined.

### BACKGROUND

Speech intelligibility refers to the clarity and comprehensibility of spoken language, determining how easily a listener or an automatic speech recognition (ASR) system can understand the speech. In both human communication and ASR, high speech intelligibility means that individual words and phonemes are easily distinguishable, leading to accurate comprehension or transcription. Several factors influence speech intelligibility, including signal effects and language effects.

Signal effects pertain to the acoustic properties of the speech signal itself. These include the presence of background noise, reverberation, and the quality of the recording equipment. For example, high levels of background noise or poor microphone quality can degrade the speech signal, making it harder to understand. The clarity of the speech signal is also affected by the speaker's articulation, speaking rate, and volume. In ASR systems, advanced signal processing techniques, such as noise reduction and echo cancellation, are employed to mitigate these effects and improve intelligibility. Language effects, on the other hand, relate to the linguistic and phonetic characteristics of the speech. These include factors such as vocabulary size, syntax, and pronunciation variations due to accents or dialects. The complexity of the language, including the use of homophones, slang, and idiomatic expressions, also impacts intelligibility.

Achieving high speech intelligibility in ASR involves sophisticated techniques and technologies. These include advanced signal processing methods to filter out background noise, robust language models to predict and understand context, and machine learning algorithms that can adapt to different speech patterns and pronunciations. Deep learning, particularly the use of neural networks, has significantly improved ASR systems'ability to handle diverse and complex speech inputs. However, challenges still remain, especially in noisy environments or with speakers who have atypical speech patterns. Continuous research and development are focused on enhancing the ASR systems'robustness and accuracy to ensure they can perform well across various real-world scenarios, thus improving user experience and expanding the applicability of speech recognition technology.

Intrusive speech intelligibility estimation, while effective in providing accurate measurements of how well speech can be understood, comes with several drawbacks. One of the primary cons is that it requires access to a clean, reference version of the speech signal for comparison. This necessity makes it impractical in real-time or large-scale applications where obtaining such reference signals is either impossible or highly resource-intensive. Consequently, intrusive methods are less suitable for dynamic environments where speech is continuously generated, such as in live broadcasts, teleconferences, or real-time communication systems.

Another significant drawback is the computational complexity and time consumption associated with intrusive methods. The process involves detailed signal processing and comparison tasks that can be computationally demanding. This complexity can lead to delays and increased costs, especially when evaluating large datasets or deploying the method in resource-constrained environments.

Human speech intelligibility evaluation is both highly labor-intensive and introduces the potential for subjective bias.

### BRIEF DESCRIPTION OF THE DRAWINGS

FIG. 1 is a flow chart of an implementation of a speech intelligibility estimation process;

FIG. 2 is a diagrammatic view of an implementation of the speech intelligibility estimation process;

FIGS. 3A and 3B are diagrams of ground truth label generation processes of the speech intelligibility estimation process;

FIG. 4 is a further detailed diagrammatic view of an implementation of the speech intelligibility estimation process;

FIG. 5 is a diagrammatic view of a computer system and the secure speech intelligibility estimation process coupled to a distributed computing network.

Like reference symbols in the various drawings indicate like elements.

### DETAILED DESCRIPTION

As will be discussed in greater detail below, implementations of the disclosure are directed to a method and system for non-intrusive speech intelligibility estimation using features typically processed in an automatic speech recognition (ASR) system. In an embodiment, the determined speech intelligibility estimation is used to control the operation of an ASR system. For example, if the determined speech intelligibility is below a threshold, an output from an ASR system may be discarded since, based on the low speech intelligibility, the output may be deemed unreliable. The system operates in a non-intrusive manner by using features or embeddings derived from encoder layers of an encoder-decoder ASR system. By using the features generated by an ASR encoder as the input to the intelligibility estimation system, the ASR encoder features are used to perform disentanglement of intelligibility-relevant information from intelligibility-irrelevant information, such as accent, pitch, level, etc. This gives the advantage of allowing the system to use features from large ASR models which have already been optimized on enormous amounts of data, as well as the option to combine features from multiple layers of ASR systems and/or multiple individual ASR systems that have different goals, such as large multi-lingual recognizers, phoneme recognizers, etc.

These features enable non-intrusive estimation of intrusive objective intelligibility metrics such as those generated by short-term objective intelligibility (STOI) and extended short-term objective intelligibility ESTOI protocols, which are based on the correlation coefficient in short-term temporal envelopes between the clean and degraded signals and have a strong monotonic relation with subjective speech intelligibility scores (such as obtained by listening tests of noisy speech which has been processed by various enhancement algorithms).

Implementations of the disclosure are configured to generate estimations of speech intelligibility resulting from acoustic conditions in a speech signal, such as background noise, reverberation, echo, signal-to-noise ratio (SNR), distortion, etc. Estimations of speech intelligibility are useful for a number of ASR and other related speech processing systems:

Control of ASR errors—When speech intelligibility is low, ASR will nevertheless attempt to recognize the sounds and output the most likely text. In such a situation, the text may be far from what was actually spoken (because of the poor intelligibility), if it recognized at all, resulting in possible deletion/insertion or substitution errors. Depending on the application, such errors could lead to offensive/incorrect transcriptions. A speech intelligibility estimator could be used to flag/suppress text output from ASR transcripts in such cases, avoiding a poor user experience.

Optimizing speech enhancement—Speech enhancement algorithms improve the quality and/or intelligibility of speech. Such speech enhancement processing is normally controlled by parameters that set the way the algorithm operates, or control how aggressively the noisy signal should be processed, trading off between noise reduction and speech distortion. Finding the sweet spot of this trade off may traditionally be done using an offline approach involving many lab-based experiments. Alternatively, the control of a speech enhancement algorithm may be performed by an online adaptive controller. In both such cases, the use of a speech intelligibility estimator will bring many advantages including automating/speeding up lab-based testing and providing a dynamic and meaningful objective function for adaptive online optimization.

Data Selection for Text-To-Speech (TTS)—the present method and system could be used to select data with high intelligibility for training TTS systems (which typically require high quality speech to be able to train).

By using the features generated by an ASR encoder as the input to the intelligibility estimation system, the ASR encoder features are used to perform disentanglement of intelligibility-relevant information from intelligibility-irrelevant information, such as accent, pitch, level, etc. For example, ASR systems are trained such that if two signals with the exact same linguistic speech content (intelligibility-relevant information) but different acoustic content (male speaker v. female speaker, noisy background v. quiet, etc.) (intelligibility-irrelevant information), the ASR system is configured to produce the same text output for the two signals. To do this well, ASR systems must ignore all of this extraneous intelligibility-irrelevant information. This gives the advantage of allowing the system to use features from large ASR models which have already been optimized on enormous amounts of data, as well as the option to combine features from multiple layers of ASR systems and/or multiple individual ASR systems that have different goals, such as large multi-lingual recognizers, phoneme recognizers, etc. Additionally, the ASR features can be combined with features representing the background acoustic information, as well as the spectral features directly, to provide the model with even more information. Finally, to get accurate estimations of speech intelligibility, it is advantageous to only evaluate the signal over periods of speech. By jointly estimating voice activity (VAD information), the model is able to self-report the regions from which the intelligibility estimation should be performed. In other words, the speech intelligibility estimation process is only performed on portions of the signal that are determined to contain speech.

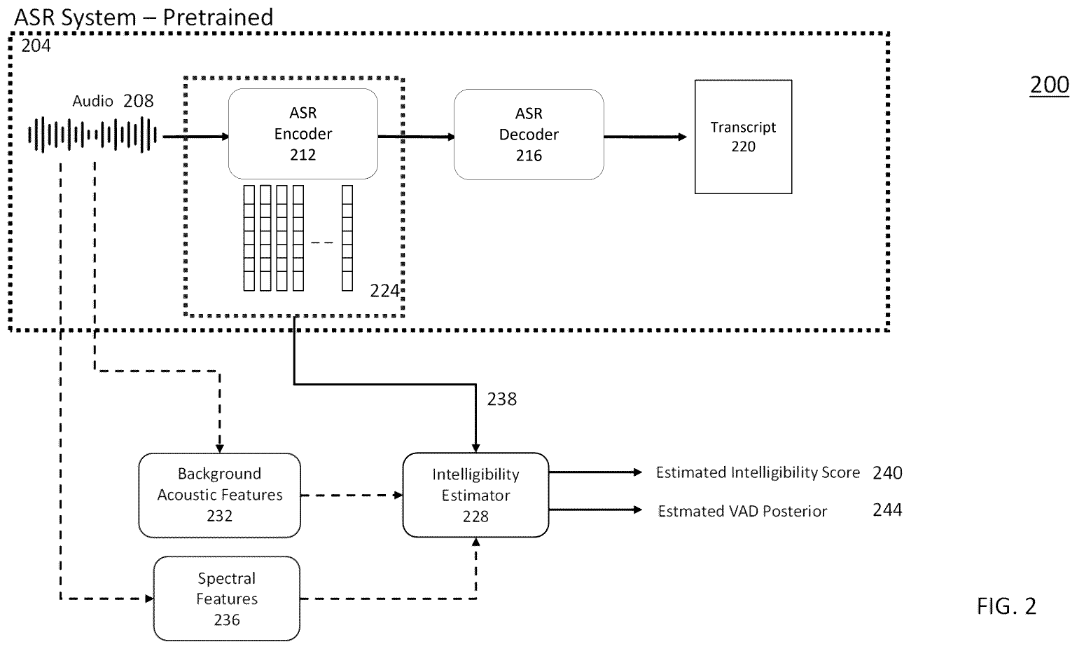

Referring now to FIG. 2, an embodiment of the disclosure will be described. Speech intelligibility estimation system 200 includes a pretrained ASR system 204 which receives an audio speech signal 208 and processes the signal to generate a transcript 220. ASR system 204 includes an ASR encoder 212 and an ASR decoder 216.

ASR encoder 212 is responsible for transforming raw audio input 208 into a series of high-level, abstract features that can be used for further processing and recognition. The encoder typically consists of multiple layers 224 of neural networks, such as convolutional neural networks (CNNs), recurrent neural networks (RNNs), or transformer models, each designed to capture different aspects of the audio signal.

When audio signal 208, such as a spoken sentence, is fed into the ASR system 204, the ASR encoder 212 processes it in stages. Initially, the raw audio signal 208 is converted into acoustic features, such as Mel-frequency cepstral coefficients (MFCCs) or spectrograms, which are more suitable for analysis. These intermediate features are then passed through the encoder's layers 224, where each layer progressively refines and abstracts the information. For instance, CNN layers might extract local temporal and spectral patterns, RNN layers could model the sequential nature of speech, and transformer layers might capture long-range dependencies and contextual information.

Each layer 224 may include various neural network units like convolutional layers, recurrent layers, or transformers. At each layer 224, the encoder 212 extracts and refines features from the audio input signal 208 (in the first layer), with each subsequent layer refining features processed in the previous layer, progressively transforming the raw waveform into a more abstract and informative representation. These intermediate representations are known as encoder activations or features 238. Encoder activations encapsulate features of speech that are needed to generate accurate transcriptions. An additional approach would be to use a weighted combination of layers rather than one layer directly, which could have the effect of pulling different information from different layers 224 of the ASR encoder 212.

The effectiveness of the encoder is crucial for the overall performance of the ASR system, as it directly influences the quality and accuracy of the speech recognition process. By extracting meaningful and discriminative features from the audio input, the encoder enables the ASR system to accurately recognize and transcribe spoken language, even in challenging conditions such as noisy environments or varied accents.

ASR decoder 216 is the component responsible for converting the intermediate representations 238 generated by the encoder 212 into readable text. The decoder 216 operates by interpreting the high-level features extracted from the audio signal 208, aligning them with linguistic units such as phonemes, words, or characters, and producing a coherent and accurate transcription 220 of the spoken input.

As is described in detail below, speech intelligibility estimation system 200 further includes ineligibility estimator 228, which receives encoder activations 240 and, optionally, background acoustic features 232 and spectral features 236 and, based on these inputs, generates an estimated intelligibility score 240 and, optionally, an estimated VAD posterior 244.

Background acoustic features 232 refer to the various characteristics of the audio signal that are related to the environment in which the speech is recorded, rather than the speech itself. These features include elements such as ambient noise, reverberation, echo, and other sounds that may be present in the background. These non-speech sounds can significantly impact the performance of ASR systems by making it more challenging to accurately isolate and transcribe the spoken words.

Spectral features 236 are elements derived from the frequency domain representation of audio signals, used to capture the essential characteristics of speech. These features provide detailed information about the energy distribution across various frequency bands, which is used for distinguishing different speech sounds. Spectral features are typically extracted through signal processing techniques such as the Short-Time Fourier Transform (STFT), which converts the time-domain audio signal into a time-frequency representation, highlighting how the signal's energy varies over time and frequency. Spectral features 236 are a class of features that non-intrusive speech intelligibility metrics typically use as inputs. In an embodiment which uses background acoustic features and/or spectral features to generate the estimated intelligibility score, such background acoustic features and/or spectral features are used in the training of the ASR system.

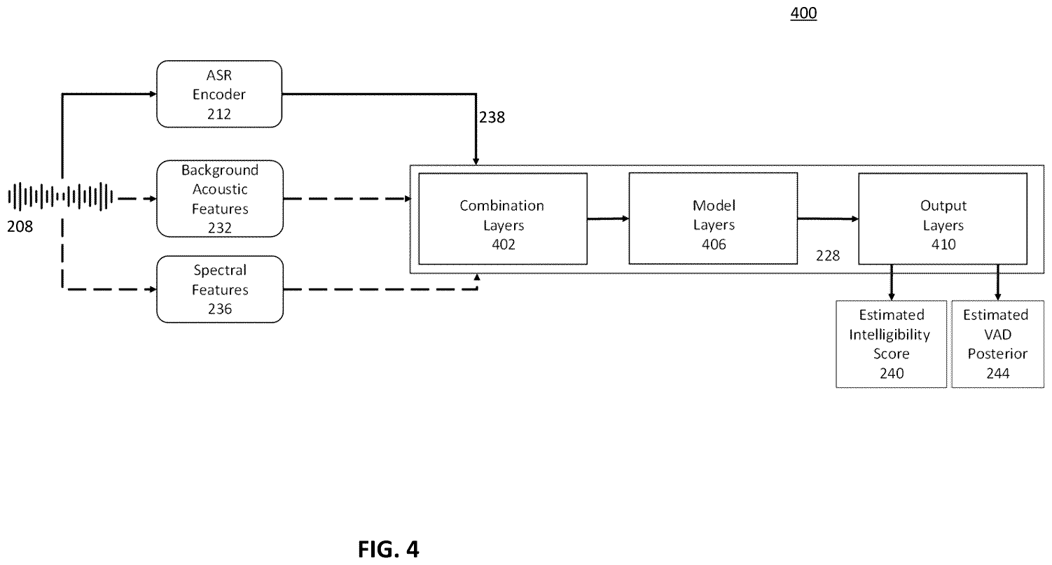

FIG. 4 is a block diagram including a more detailed depiction of intelligibility estimator 228. Intelligibility estimator 228 includes a deep neural network (DNN), comprising combination layers 402, model layers 406, and output layers 410. Combination layers 402 are layers within the neural network architecture that integrate features from multiple preceding layers to enhance the model's ability to capture and represent complex patterns in speech data. These layers combine different types of information extracted at various stages of the network. Intelligibility estimator 228 consists of several layers, which may include convolutional layers, recurrent layers, and transformer layers, each designed to process the audio signal in distinct ways. Convolutional layers may focus on capturing local temporal and spectral features, while recurrent layers may model long-term dependencies in the speech signal. Combination layers aggregate the outputs from these diverse layers, creating a richer and more comprehensive representation of the audio data. As such, combination layers 402 take in multiple features (from one or more layers of one or more ASR models as well as the optional background acoustic features 232 and spectral features 236), normalizes them and combines them into a format suitable for the main model layers 406.

Model layers 406 are composed of various types of neural network architectures, such as convolutional neural networks (CNNs), recurrent neural networks (RNNs), long short-term memory networks (LSTMs), or transformers. CNNs are particularly effective at capturing local patterns and features in the audio signal, while RNNs and LSTMs are adept at handling the temporal dependencies inherent in speech. Transformers, known for their attention mechanisms, excel at capturing long-range dependencies and contextual relationships in the speech data. Each layer transforms the input data in increasingly abstract ways, gradually building up higher-level representations of the speech signal. For instance, early layers might detect basic phonetic elements, while deeper layers might recognize more complex structures such as words or phrases. Generally, in intelligibility estimator 228, model layers 406 receive the combined inputs from combination layers 402 and learn to map those to the output layers 410. The output layers 410 estimate the intelligibility score 240 and, optionally, the VAD posterior 244 from the last of the model layers 406.

In an example embodiment of th disclosure, speech intelligibility is scored on a scale from 0 to 1. This scoring method provides a clear and standardized way to quantify how well speech can be understood. A score of 0 indicates that the speech is completely unintelligible, meaning that the signal includes signal and/or language effects that would make it impossible for the listener or the system to discern any meaningful content from the audio. Conversely, a score of 1 represents perfect intelligibility, e.g., there is nothing acoustically that occludes the speech content from being understood or indicates that there would be an issue with it being understood, Other speech intelligibility scoring systems may be scaled according to a different criteria, but indicate a range of speech intelligibility from none to complete understandability.

Voice Activity Detection (VAD) posterior 244 refers to the probability or confidence score that a given segment of an audio signal contains speech rather than silence or background noise. This score typically ranges from 0 to 1, where a value close to 1 indicates a high probability that the segment contains speech, while a value close to 0 suggests it is likely non-speech. The VAD process begins with the analysis of the audio signal using various acoustic features such as energy levels, spectral content, and temporal dynamics. These features are input into a machine learning model or statistical classifier that has been trained to distinguish between speech and non-speech segments. The model processes the input and produces a posterior probability for each time frame or segment of the audio. For example, if a segment of audio is analyzed and the VAD system assigns it a posterior value of 0.9, this means there is a 90% probability that this segment contains speech. Conversely, a posterior value of 0.2 would indicate a 20% probability of speech, suggesting that it is more likely to be silence or background noise.

These posterior scores are then used in the ASR (Automatic Speech Recognition) system to make decisions about which parts of the audio should be processed for speech recognition. By focusing only on segments with high VAD posterior scores, the system can improve efficiency and accuracy, as it avoids wasting resources on non-speech segments.

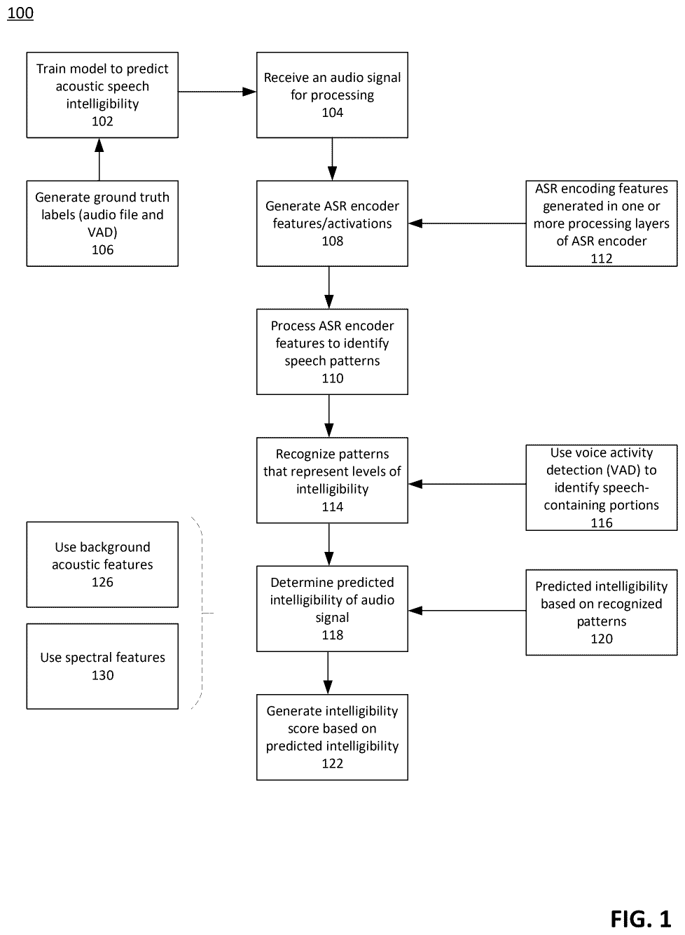

FIG. 1 is a flow diagram 100 depicting the method for speech intelligibility estimation in accordance with an embodiment of the disclosure. At 106, audio file and VAD ground truth labels are generated for training the intelligibility estimator 228. An audio file ground truth label refers to the accurate and manually verified text transcription of an audio recording. These labels serve as a reference against which the ASR system's performance is measured. During the development and training phases of ASR models, ground truth labels are used for supervised learning, enabling the model to learn the correct mapping from spoken words to written text.

To create audio file ground truth labels, human annotators listen to the audio recordings and meticulously transcribe the spoken content, ensuring that the text accurately reflects every word, phrase, and nuance of the speech. This process often involves multiple stages of review and correction to maintain a high level of accuracy. The resulting transcriptions are free of errors and ambiguities, providing a reliable benchmark for the ASR system. In the training process, the ASR model is fed audio recordings along with their corresponding ground truth labels. The model's output is then compared to these labels, and any discrepancies are used to adjust the model's parameters. This iterative process helps the ASR system learn to produce increasingly accurate transcriptions.

VAD ground truth labels refer to the precise annotation of segments within an audio recording that indicate whether speech is present or absent. These labels are manually created and verified by human annotators who listen to the audio and mark the start and end points of speech segments. This process involves identifying not only where speech occurs but also where there are pauses, silences, or background noise without speech. Creating ground truth VAD labels involves listening to the audio recordings and meticulously annotating each segment, ensuring that the labels accurately reflect the presence of speech. These annotations provide a reliable reference for training and evaluating VAD algorithms. The labeled data helps the VAD system learn to distinguish between speech and non-speech segments in various acoustic conditions, including noisy environments and different speaking styles.

In the training phase of a VAD system, the ground truth labels are used to teach the model how to identify speech segments accurately. The model's predictions are compared to these labels, and any errors are used to adjust and improve the system's accuracy. During evaluation, the ground truth VAD labels serve as a benchmark to measure the performance of the VAD system, ensuring it can reliably detect speech in real-world applications. When training, the output layer is configured to provide estimations for both speech intelligibility 240 and VAD posteriors 244, and two separate loss values are computed, one for speech intelligibility and one for VAD posteriors. These loss values are then weighted and combined to produce the overall loss, which is ultimately used to update the model weights in the training loop.

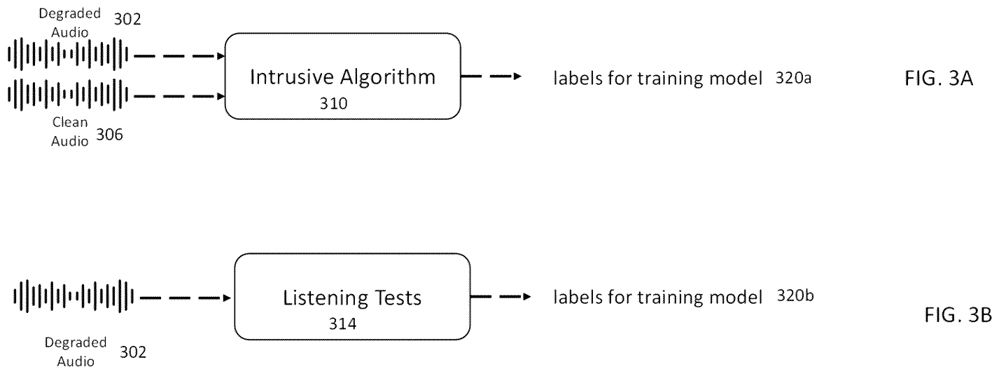

FIG. 3A depicts use of an intrusive algorithm 310 to generate ground truth labels, in which a degraded audio signal 302 is compared to a corresponding clean audio signal 306 in the manner described above to generate the ground truth labels 320a. FIG. 3B depicts use of human listening tests 314 to generate ground truth labels, in which a degraded audio signal 302 is manually listened to by a human in the manner described above to generate the ground truth labels 320b.

Once the ground truth labels 320a, 320b are generated, 106, the intelligibility estimator 228 model is trained to predict acoustic speech intelligibility estimations given only ASR encoder features or activations, 102. This training involves the following steps performed in a loop in which speech intelligibility is predicted using the intelligibility estimator 228, comparing the predicted intelligibility to the ground truth label using a loss function, and updating weights associated with the intelligibility estimator 228 based on a computed loss. While the specific aspects of the features may vary, the intelligibility estimator 228 will learn the important aspects generated in the ASR layers 240 by iteratively updating itself, provided that the input features are rich enough in relevant information.

Once the intelligibility estimator 228 is trained, an audio signal 208 is received by the ASR system 204 for processing, 104. ASR encoder features 238 are generated in one or more processing layers 224 of ASR encoder 212, 108, 112, and processed to identify speech patterns in the audio signal 208, 110. Patterns that represent levels of intelligibility are recognized by intelligibility estimator 228, 114. VAD may be used to identify speech-containing portions of the audio signal to fine tune the overall accuracy of the intelligibility determination, 116. Based on the recognized patterns, 120, predicted intelligibility of the audio signal is determined, 118.

Background acoustic features 232 and/or spectral features 236 of the audio signal 208 may be used in the intelligibility determination, 126, 130. In such an embodiment, in order to enable use of these background acoustic features 232 and/or spectral features 236 in the intelligibility estimation process, these features must also be used in the training of the intelligibility estimator 228 The ASR system 204 is trained independently of the intelligibility estimator 228. In an embodiment in which only the ASR encoder features 238 are to be used by intelligibility estimator 228, the intelligibility estimator 228 is trained using only the encoder features 228. In an embodiment in which the background acoustic features 232 and/or spectral features 236 are to be used in the intelligibility estimation process, the intelligibility estimator 228 is trained using these background acoustic features 232 and/or spectral features 236 in addition to the encoder features 238. Based on the predicted intelligibility determined at 118, an intelligibility score is generated, 122.

Accordingly, implementations of the disclosure generate speech intelligibility estimations using ASR activations generated by an ASR encoder of an ASR system. This gives the advantage of allowing the system to use features from large ASR models which have already been optimized on enormous amounts of data, as well as the option to combine features from multiple layers of ASR systems and/or multiple individual ASR systems that have different goals, such as large multi-lingual recognizers, phoneme recognizers, etc. The system and method operates in a non-intrusive manner, eliminating the need for a clean audio signal when determining intelligibility, thus reducing processing complication, inefficiency, and bandwidth issues.

### System Overview

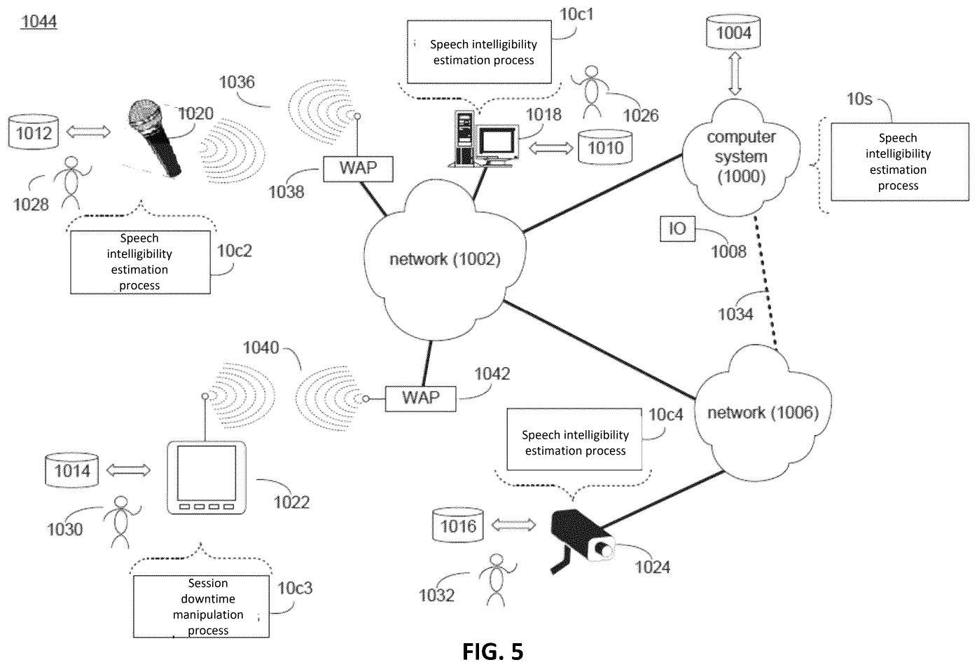

Referring to FIG. 5, there is shown a speech intelligibility estimation process 10. Speech intelligibility estimation process 10 may be implemented as a server-side process, a client-side process, or a hybrid server-side/client-side process. For example, speech intelligibility estimation process 10 may be implemented as a purely server-side process via computational cost reduction process 10s. Alternatively, speech intelligibility estimation process 10 may be implemented as a purely client-side process via one or more of speech intelligibility estimation process 10c1, speech intelligibility estimation process 10c2, speech intelligibility estimation process 10c3, and speech intelligibility estimation process 10c4. Alternatively still, speech intelligibility estimation process 10 may be implemented as a hybrid server-side/client-side process via speech intelligibility estimation process 10s in combination with one or more of speech intelligibility estimation process 10c1, speech intelligibility estimation process 10c2, speech intelligibility estimation process 10c3, and speech intelligibility estimation process 10c4.

Accordingly, speech intelligibility estimation process 10 as used in this disclosure may include any combination of speech intelligibility estimation process 10, speech intelligibility estimation process 10c1, speech intelligibility estimation process 10c2, speech intelligibility estimation process 10c3, and speech intelligibility estimation process 10c4.

Speech intelligibility estimation process 10s may be a server application and may reside on and may be executed by a computer system 1000, which may be connected to network 1002 (e.g., the Internet or a local area network). Computer system 1000 may include various components, examples of which may include but are not limited to: a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (SaaS) systems, a cloud-based computational system, and a cloud-based storage platform.

A SAN includes one or more of a personal computer, a server computer, a series of server computers, a minicomputer, a mainframe computer, a RAID device and a NAS system. The various components of computer system 1000 may execute one or more operating systems.

The instruction sets and subroutines of computational cost reduction process 10s, which may be stored on storage device 1004 coupled to computer system 1000, may be executed by one or more processors (not shown) and one or more memory architectures (not shown) included within computer system 1000. Examples of storage device 1004 may include but are not limited to: a hard disk drive; a RAID device; a random-access memory (RAM); a read-only memory (ROM); and all forms of flash memory storage devices.

Network 1002 may be connected to one or more secondary networks (e.g., network 1004), examples of which may include but are not limited to: a local area network; a wide area network; or an intranet, for example.

Various IO requests (e.g., IO request 1008) may be sent from speech intelligibility estimation process 10s, speech intelligibility estimation process 10c1, speech intelligibility estimation process 10c2, speech intelligibility estimation process 10c3 and/or speech intelligibility estimation process 10c4 to computer system 1000. Examples of IO request 1008 may include but are not limited to data write requests (i.e., a request that content be written to computer system 1000) and data read requests (i.e., a request that content be read from computer system 1000).

The instruction sets and subroutines of speech intelligibility estimation process 10c1, speech intelligibility estimation process 10c2, speech intelligibility estimation process 10c3 and/or computational cost reduction process 10c4, which may be stored on storage devices 1010, 1012, 1014, 1016 (respectively) coupled to client electronic devices 1018, 1020, 1022, 1024 (respectively), may be executed by one or more processors (not shown) and one or more memory architectures (not shown) incorporated into client electronic devices 1018, 1020, 1022, 1024 (respectively). Storage devices 1010, 1012, 1014, 1016 may include but are not limited to: hard disk drives; optical drives; RAID devices; random access memories (RAM); read-only memories (ROM), and all forms of flash memory storage devices. Examples of client electronic devices 1018, 1020, 1022, 1024 may include, but are not limited to, personal computing device 1018 (e.g., a smart phone, a personal digital assistant, a laptop computer, a notebook computer, and a desktop computer), audio input device 1020 (e.g., a handheld microphone, a lapel microphone, an embedded microphone (such as those embedded within eyeglasses, smart phones, tablet computers and/or watches) and an audio recording device), display device 1022 (e.g., a tablet computer, a computer monitor, and a smart television), a hybrid device (e.g., a single device that includes the functionality of one or more of the above-references devices; not shown), an audio rendering device (e.g., a speaker system, a headphone system, or an earbud system; not shown), and a dedicated network device (not shown).

Users 1026, 1028, 1030, 1032 may access computer system 1000 directly through network 1002 or through secondary network 1006. Further, computer system 1000 may be connected to network 1002 through secondary network 1006, as illustrated with link line 1034.

The various client electronic devices (e.g., client electronic devices 1018, 1020, 1022, 1024) may be directly or indirectly coupled to network 1002 (or network 1006). For example, personal computing device 1018 is shown directly coupled to network 1002 via a hardwired network connection. Further, machine vision input device 1024 is shown directly coupled to network 1006 via a hardwired network connection. Audio input device 1022 is shown wirelessly coupled to network 1002 via wireless communication channel 1036 established between audio input device 1020 and wireless access point (i.e., WAP) 1038, which is shown directly coupled to network 1002. WAP 1038 may be, for example, an IEEE 802.11a, 802.11b, 802.11g, 802.11n, Wi-Fi, and/or any device that is capable of establishing wireless communication channel 1036 between audio input device 1020 and WAP 1038. Display device 1022 is shown wirelessly coupled to network 1002 via wireless communication channel 1040 established between display device 1022 and WAP 1042, which is shown directly coupled to network 1002.

The various client electronic devices (e.g., client electronic devices 1018, 1020, 1022, 1024) may each execute an operating system, wherein the combination of the various client electronic devices (e.g., client electronic devices 1018, 1020, 1022, 1024) and computer system 1000 may form modular system 1044.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving a degraded audio signal in a pretrained automatic speech recognition (ASR) system;
generating ASR encoder features of the degraded audio signal;
processing the ASR encoder features to identify patterns in the ASR encoder features;
recognizing patterns that represent levels of intelligibility of the audio signal, resulting in recognized patterns; and
determining a predicted intelligibility of the audio signal based on the recognized patterns of the ASR encoder features.

2. The computer-implemented method of claim 1 further including generating an intelligibility score based on the predicted intelligibility.

3. The computer-implemented method of claim 2 wherein the ASR encoding features are generated in one or more processing layers of an ASR encoder of the ASR system.

4. The computer-implemented method of claim 3 wherein the one or more processing layers are selected based on evaluating output quality from each layer.

5. The computer-implemented method of claim 4 further comprising using voice activity detection (VAD) to identify portions of the audio signal containing speech to focus on the recognized patterns of the speech portion.

6. The computer-implemented method of claim 2 further comprising using background acoustic features of the audio signal to determine the predicted intelligibility.

7. The computer-implemented method of claim 2 further comprising using spectral features of the audio signal to determine the predicted intelligibility.

8. A computing system comprising:
a memory; and
a processor to:
process a degraded audio signal in a pretrained automatic speech recognition (ASR) system;
generate ASR encoder features of the degraded audio signal;
process the ASR encoder features to identify patterns in the ASR encoder features;
recognize patterns that represent levels of intelligibility of the audio signal, resulting in recognized patterns;
determine a predicted intelligibility of the audio signal based on the recognized patterns of the ASR encoder features; and
generate an intelligibility score based on the predicted intelligibility.

9. The computer-implemented method of claim 8 wherein the ASR encoding features are generated in one or more processing layers of an ASR encoder of the ASR system.

10. The computer-implemented method of claim 9 wherein the one or more processing layers are selected based on evaluating output quality from each layer.

11. The computer-implemented method of claim 10 further comprising using voice activity detection (VAD) to identify portions of the audio signal containing speech to focus on the recognized patterns of the speech portion.

12. The computer-implemented method of claim 8 further comprising using background acoustic features of the audio signal to determine the predicted intelligibility.

13. The computer-implemented method of claim 8 further comprising using spectral features of the audio signal to determine the predicted intelligibility.

14. A computer program product residing on a non-transitory computer readable medium having a plurality of instructions stored thereon which, when executed by a processor, cause the processor to perform operations comprising:
processing a degraded audio signal in a pretrained automatic speech recognition (ASR) system;
generating ASR encoder features of the degraded audio signal in one or more processing layers of an ASR encoder of the ASR system;
processing the ASR encoder features to identify patterns in the ASR encoder features;
recognizing patterns that represent levels of intelligibility of the audio signal, resulting in recognized patterns; and
determining a predicted intelligibility of the audio signal based on the recognized patterns of the ASR encoder features.

15. The computer-implemented method of claim 14 further including generating an intelligibility score based on the predicted intelligibility.

16. The computer-implemented method of claim 15 wherein the one or more processing layers are selected based on evaluating output quality from each layer.

17. The computer-implemented method of claim 16 further comprising using voice activity detection (VAD) to identify portions of the audio signal containing speech, resulting in speech-containing portions of the audio signal.

18. The computer-implemented method of claim 17 further comprising processing the speech-containing portions of the audio signal to focus on the recognized patterns of the ASR encoder features.

19. The computer-implemented method of claim 15 further comprising using background acoustic features of the audio signal to determine the predicted intelligibility.

20. The computer-implemented method of claim 15 further comprising using spectral features of the audio signal to determine the predicted intelligibility.
